(19) United States
(12) Patent Application Publication
(10) Pub. No.: US 2003/0028680 A1
(43) Pub. Date: Feb. 6, 2003

(54) Application manager for a content delivery system

(76) Inventor: Frank Jin, Issaquah, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/893,351

(22) Filed: Jun. 26, 2001

(51) Int. Cl. G06F 9/46; G06F 9/00

(52) U.S. Cl. 709/313; 709/107

(57) ABSTRACT

An applications manager, executed with application resources in a streaming media retrieval system, which monitors selected or registered applications and initiates recovery procedures in the event of an error. An application manager thread is instantiated for each application process to be monitored. The application process is monitored for a state message that is periodically transmitted by the application process. If the state message is not received within a period, the application manager is configured to autonomously initiate one of a number of recovery processes, which range from process-level to operating system-level.

### BACKGROUND OF THE INVENTION

An application environment is a computing environment in which one or more application programs cooperatively operate to produce a result. One specific application environment is a streaming media delivery and/or retrieval system. In such a system, several applications are executed to allow a user to retrieve digital content from a content source.

Application environments can be very complex, requiring adherence to strict timing and performance parameters. Accordingly, an application environment will require controls for ensuring such parameters are met. One need is for an applications manager, within or external to the application environment, which can monitor selected or registered applications and initiate recovery procedures in the event of an error.

### BRIEF DESCRIPTION OF THE DRAWING

FIG. 1 illustrates a content delivery system hosting various applications.

FIG. 2 illustrates a multi-layered application manager process according to an embodiment of the invention.

FIG. 3 illustrates a state machine for an application manager.

FIG. 4 is a flow chart illustrating an application management process according to the invention.

### DETAILED DESCRIPTION OF THE PREFERRED EMBODIMENTS

This invention relates to an application manager that is configured to monitor specific parts of a content delivery system. If any unexpected error occurs and causes either part of the system or the whole system to be hung-up, the application manager will initiate a corresponding recovery process based on the error detected. Because of the general complexity of content delivery, and specifically those systems using COM, NT drivers and services, and IE/DHTML pages, it is very difficult to monitor each running part of the system, or to initiate recovery of a failed part when a failure is detected. This invention provides an architecture for monitoring each running application within the content delivery application environment that is registered with the applications manager, providing robustness without significantly increasing the complexity of the system.

The invention, embodied as a method, includes the steps of monitoring one or more applications for periodic state messages generated by selected application processes running in an applications environment. When no state message is received within a period, the application manager will record an error for the associated application process and, based on the recorded error, automatically execute one or more of a plurality of recovery procedures.

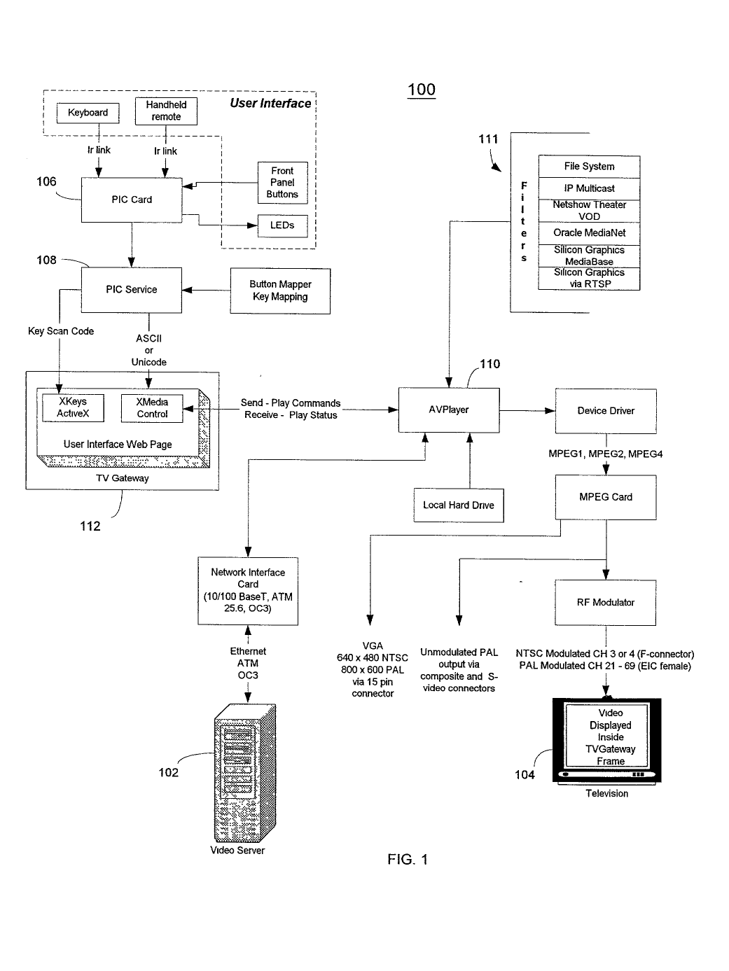

With reference to FIG. 1, there is shown one example functional block diagram of a content delivery system 100 for delivering various forms of media from various types of content sources. One such content source is a video server 102. Another type of content source is an Internet server configured to provide content over the Internet compliant with the Internet Protocol (IP) for packet-based transmission. Still other types of content sources are contemplated, as are transmission media. The content is ultimately delivered to a user at a video display 104, having been processed and transmitted through other parts of the system 100.

The system 100 further includes a programmable interface controller (PIC) card 106 connected with a PIC service processor 108. The PIC service 108 is responsible for communicating with the input/output hardware sub-systems, including peripheral user input devices. An AVPlayer 110 is a service that enables playback of audio and video, or other content, to the video display 104, and controls and instantiates a number of different types of filter graphs 111. Several known filter graphs are shown in FIG. 1.

A TVGateway 112 is a browser application that hosts and generates a user interface web page, for interactive communication between the user via the PIC service 108 and the content source 102. The TVGateway 112 includes control objects, such as ActiveX control XKeys for example, which trap keystrokes and mouse movements passed by the PIC service processor 108. These, in turn, control the AVPlayer 106. The TVGateway 112 also includes several program tools for receiving and processing user commands. Each block in the functional block diagram can represent an application program or application process. FIG. 1 thus illustrates merely one example of an application environment in the form of a content delivery system, to show the complex interconnections of various application programs and processes to be monitored by an application manager.

The application manager is embodied as autonomous logic that runs in the background within an application environment associated with a content client. The application manager monitors the performance of essential application programs in the application environment to detect, and initiate recovery from, a major application failure. The application manager includes a monitoring program, referred to herein as a “watch dog” system, or “WD” hereinafter for simplicity. The WD runs in multiple levels. At one level, a WD program expects an “I am alive” state message from each monitored application within a specific time period. If the application program does not “feed” the WD with a state message within the allotted time, the application manager assumes the application program is not running, and guides the media client through an orderly recovery process in an attempt to reset the system software and return the content client to a normal operation condition.

The application manager logs a recovery process history into a persistent storage, such as a disk drive connected with the system. The disk drive can be an optical or magnetic disk drive system. Other types of storage include magnetic tape media, random-access memory (RAM), or any other type of persistent or semi-persistent memory. If multiple recoveries are required within a given time, the application manager escalates the recovery procedure to a higher level.

In one embodiment, the application manager functions without a user or developer interface. The application manager checks the status of the keyboard and mouse drivers at system start-up. After the system powers up without any errors, the application manager monitors the status of application programs to ensure they are communicating correctly. The following three applications are examples of applications being monitored by the application manager: the PIC Service 108, or the executable code that forms the PIC Service 108; the AVPlayer 110, or its executable code; and the TVGateway 112 or its executable code. Other applications may also be monitored in accordance with the invention. If an application fails to communicate with the application manager, it is flagged as having a problem and an appropriate recovery routine is started.

In one embodiment, the application manager utilizes Interprocess Communication (IPC), which is the ability of one task or process to communicate with another task or process in a multitasking operating system. Common methods for executing IPC include pipes, semaphores, shared memory, queues, signals, and mailboxes. In order to have a convenient and consistent IPC architecture, the application manager utilizes a component object model (COM) server called MessageRegistrar.

In an embodiment, the application manager also utilizes Remote Procedure Calls (RPC), which lets individual procedures of an application run on systems anywhere on the network. The RPC extends the typical local procedure call model by supporting direct calls in a C-like language, called the Interface Definition Language (IDL), to procedures on remote systems.

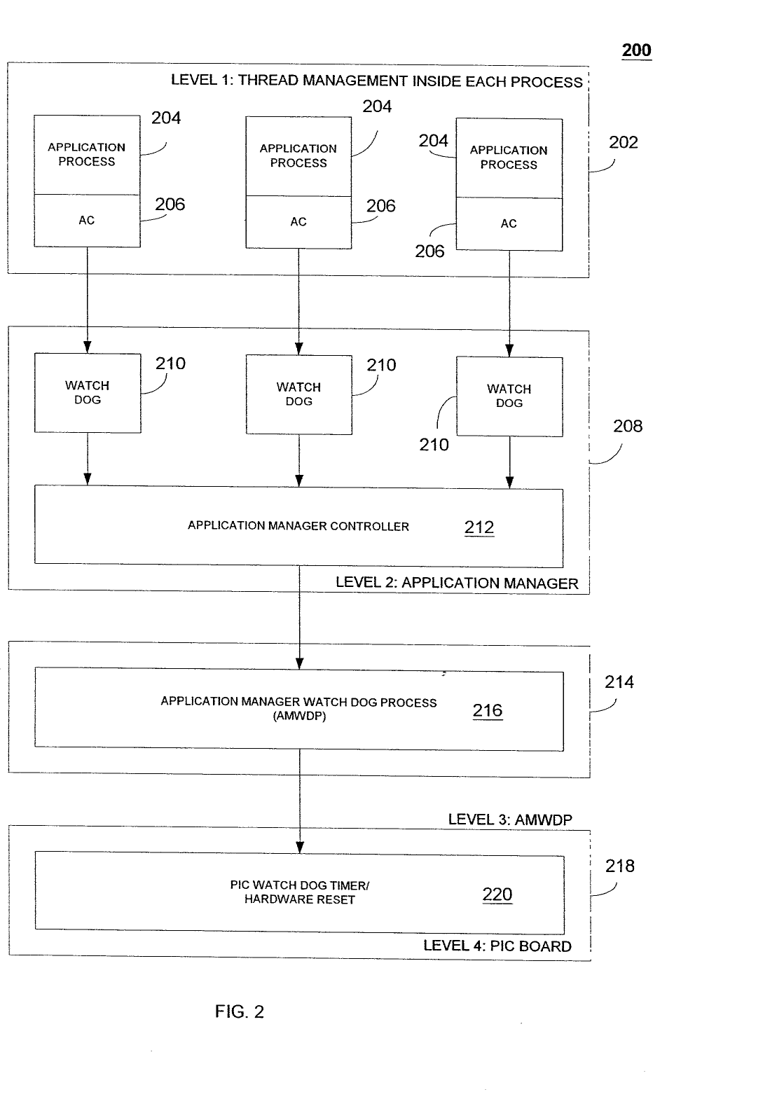

According to a specific exemplary embodiment, the application manager includes one or more parent and child relationships. The different application manager parts are siblings to each other and the relationships are mainly COM function calls. With the introduction of every child, there is a corresponding and known “parent” application manager that manages the whole system and which knows all of the children it is managing. Accordingly, a WD exists at various levels, having certain roles and functionality. The multiple levels of relationships are shown with reference to FIG. 2.

In general, a level 1 WD may or may not be required for an application process depending whether that application is explicitly creating new threads. In order to watch the threads created by RPC runtime, a client-managed timer is needed to notify the application manager that a certain executable COM server is not responding. The application manager has to be designed and implemented to be able to accept this kind of client-managed timer notifications and initiate a recovery process accordingly. If a WD on either level or a client-managed timer “fires” or activates, a certain recovery process has to take place.

According to one possible architecture, the application manager includes a four-level WD structure, as illustrated in FIG. 2. At each level, it is assumed that the WDs are fed only by their watched processes. For example, for the application manager to watch the TVGateway 112 from FIG. 1, the TVGateway must feed a WD in the application manager periodically, instead of the application manager periodically polling the TVGateway. If the TVGateway does not feed a watch dog in application manager for a certain period of time, the application manager will assume that TVGateway has failed.

In Level 1 202 of the application manager, each application 204 communicates with an application manager Connector (AC) 206. The AC 206 is preferably a COM object configured to communicate with the application manager on behalf of the application in which it resides. The application 204 represents an application program, or application process, or set of application processes. The application 204 can also be an application environment containing a number of interrelated applications.

The ACs 206 feed watch dogs 210 within Level 2 208 of the application manager. In a specific embodiment, each AC 206 initializes the application manager-related IPC (ImessageRegistrar) among all of the components in the system. It also reads the Windows NT registry to get the required information about each managed part. It then spawns a WD 210 thread for each managed application 204. In turn, the WD 210 sets up a handshaking mechanism and a kernel timer to let the managed application 204 feed the timer periodically. Then the WD 210 will “sleep” on the timer. If an application 204 fails to feed the timer, the WD 210 will “wake up” and invoke a recovery process based on registry configuration data and runtime information.

If an application 204 spawns child thread(s) explicitly, it must implement a WD 210 for each child thread to provide the thread management on the process level. For some applications, such as ComPlayer, the COM call threads can be created by RPC runtime. A different mechanism can be used to watch system-generated threads.

The application manager can implement a WD 210 for each managed application 204, and each application 204 has to periodically feed a WD to inform the application manager of its health status. Because of the implementation of the Level 1 WD, the good status from a WD on this level should indicate that all of the local threads in that process are running well.

Since the application manager needs to implement the functionality to manage all of the other parts in the system, it is possible that something will go wrong at run time inside the application manager itself under some unexpected circumstances. A Level 3 WD 216 is a dedicated application manager watch dog process, called “AMWDP” configured to watch the application manager and feed a Level 4 WD. In Level 4 218, a PIC WD 220 is implemented in the PIC and is fed by the AMWDP 216 from in Level 3 214.

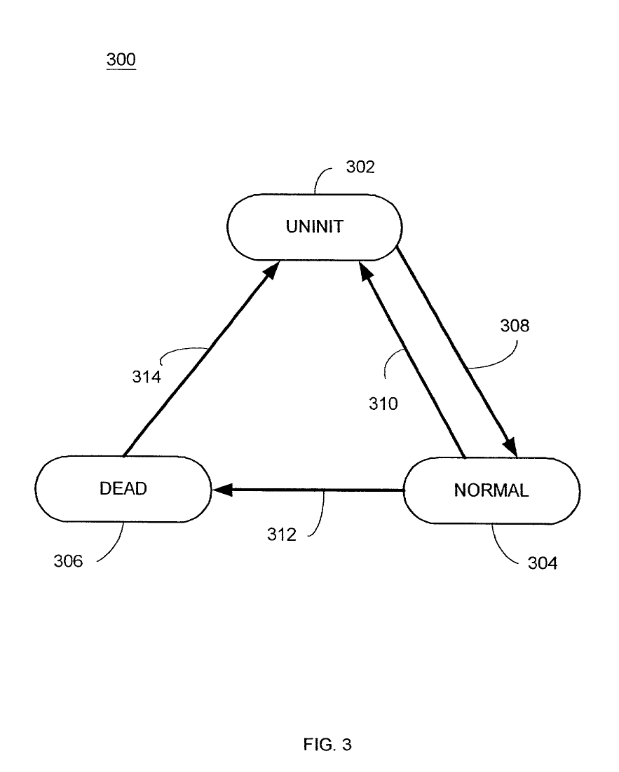

In the application manager, there is an object for each managed application, and the object is configured to encapsulate all related information for the application. The object, according to the managed application, has three states as shown in the state machine 300 in FIG. 3, UNINIT (un-initialized) 302, NORMAL (normal running) 304 and DEAD (hung up) 306. The object starts as UNINIT 302. After finishing handshaking between the managed application and the application manager WD, the state changes to NORMAL 304 via transition path 308. If the kernel timer fires and the WD wakes up, the state will change to DEAD 306 via transition path 312. If the managed application is restarted successfully without rebooting the operating system, the state will return to UNINIT 302 along transition path 310. In the case that the application manager recovers by restarting, i.e. restarting the AutoLogon user, the state may change from NORMAL 304 to UNINIT 302. Upon initiating and executing a recovery, the state reverts to the UNINIT 302 via transition path 314.

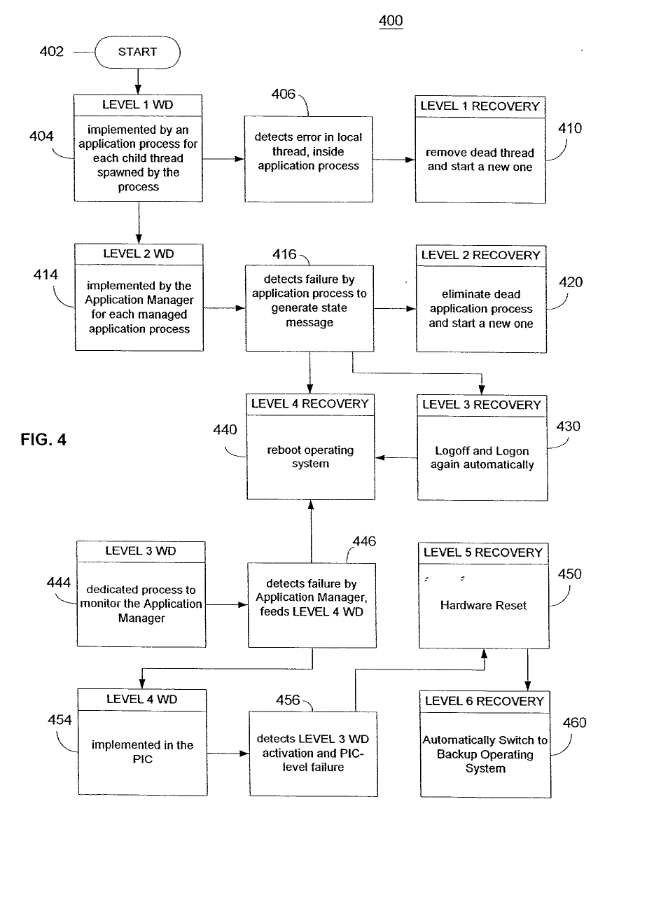

Once a failure is detected, at least one recovery process is selected from a number of recovery processes or levels of recovery, and executed to rectify the failure. According to one embodiment, six levels of recovery are available based, at least in part, on the type of failure or error, or on the system level at which the failure or error was detected. FIG. 4 is a flowchart illustrating four WD levels, the WD timer activation and detection, and the associated levels of recovery.

Level One Recovery

A Level One Recovery 410 process is triggered by the Level 1 WD 404 and takes place inside an application process. If an error is detected in a local thread of an application process, as indicated at block 406, recovery from the detected error is attempted in the local thread. The recovery action is to eliminate the dead thread and start a new one. If the thread in question houses one or more COM objects, which already have some clients, a clean recovery may not be effective at this level. If this is the case, a process can let a level 2 WD 414 timer fire, at block 416 and pass the problem to the application manager. As in the case of the Level 1 WD, Level One recovery may or may not be needed in an application process, depending on what kind of thread management is needed in a given process.

Level Two Recovery

If a Level 2 WD 414 timer fires, the application manager detects that the application watched by that timer is not working at block 416, and that some action has to be taken by the application manager. The application manager uses configuration data, such as data provided either in the Windows NT registry or in a configuration file, for example, and runtime information to decide which level of recovery to take. The Level Two Recovery 420 attempts to terminate the dead process cleanly and start a new process. The configuration data must specify which processes the application manager shall try first at a Level Two Recovery 420, or whether to go directly to a Level Three Recovery 430. The Level Two Recovery 420 history is stored in a persistent storage.

Level Three Recovery

If the application manager detects an identical problem after execution of a Level Two Recovery 420 process, it will advance to a Level Three Recovery 430 response directly, instead of executing the Level Two Recovery 420 again. A Level Three Recovery 430 executes an automatic Logoff and Logon again. This process will shut down all of the processes running in the security context of AutoLogon. This recovery process is faster than rebooting the operating system or resetting the hardware platform.

Level Four Recovery

The Level Four Recovery 440 can be triggered either from a Level 2 WD timer, represented by block 416, or from the Level 3 WD 444, as detected by the Level 3 WD timer 446. The Level Four Recovery 440 executes a reboot of the system's operating system. In one exemplary embodiment, the system employs the Microsoft Windows™ NT operating system. If the Level 3 WD timer 446 fires in AMWDP, the Level Four Recovery 440 process will try to reboot Windows NT directly.

Level Five Recovery

Under some catastrophic conditions, a “soft” reboot might not be available. If this is the case, the AMWDP will not be able to feed the Level 4 WD 454 as represented by block 456 and, in turn, it will trigger the PIC to send a hardware reset to the main CPU.

Level Six Recovery

If a hardware reboot at the Level Five Recovery 450 also fails, it may be indicative of corruption on the hard disk. According to one embodiment, the Level Six Recovery 460 process includes automatically switching to a backup Windows NT partition. A switch to another operating system or partition is also contemplated at this level.

A description of an exemplary application management process follows. The Application Manager runs as a Windows NT service. The application manager starts to run before anything else in the system after Windows NT starts, and runs in system security context instead of AutoLogon user security context. After the initialization and handshaking with SCM, the application manager NT service will spawn a thread based on an object from class CAmController to work as the Application Manager Controller (AC). This object is the only object from class CAmController.

The AC will read the AM registry tree to get all the information needed to do the initialization. Based on the information from the registry, the controller will create an application manager descriptor and a list of managed parts descriptor to contain the information that is used to monitor each application and perform a recovery if necessary. The controller will create a WD thread based on a CAMWatchDog class for each managed application and pass the associated managed part descriptor to the WD thread.

The CAMWatchDog is a class template that implements the mechanism to do handshaking with managed parts during startup and wait on a kernel timer. The template parameter passed to CAMWatchDog, based on the RecoveryLevel from registry, is a class that knows how to recover after detecting a dead process. Three recovery classes are implemented using inheritance. In theory, any recovery class can be implemented and passed to the CAMWatchDog class template as long as it conforms to the interface defined in an abstract base class CrecoveryPolicy. The CAMWatchDog will perform the recovery as implemented in the recovery class.

A group of registry keys and values are used to configure how the application manager will behave and what will be under the application manager's management.

The application manager has four values

1. RecoveryEnabled [DWORD]: If set to 0, the application manager will do nothing. If set to non-zero, the application manager will perform the designed monitoring function.

2. ConnectionEnabled [DWORD]: If set to 0, AmConnector will not try to connect to the application manager. If set to non-zero, AmConnector will try to connect to the application manager on behalf of an application.

3. LogoffProcess [STRING]: This string gives the full path to the exe file which will perform Logoff User based on the application manager's request.

4. ManagedList [STRING]: This string lists all of the application names which are to be managed by the application manager, with the following format: name1; name2; . . . ; lastName;

In the application manager, there are an identical number of sub keys as managed applications. The name of each sub key must match its name on the ManagedList. For example, if TVGateway is one of the names on the ManagedList, then the application manager expects to find a sub key called TVGateway under the AppManager registry.

Under each sub key, there could be up to six values. The first two, Group- and Recovery-Level, are required values for all of the applications. Group [STRING] is either UserApp or NTService. RecoveryLevel [DWORD] and has three levels: 2—Restart Process; 3—Logoff User; 4—Reboot NT. The recovery level specified in RecoveryLevel is the base recovery policy where the application manager starts. If a problem is repeated, the application manager must respond differently. If the RecoveryLevel is 2, or Restart Process, four more named values need to be provided to facilitate a recovery scheme. Three of the four are NoErrPeriodLower, NoErrPeriodUpper and NumTriesOnBasePolicy. All are DWORD values. The unit values for NoErrPeriodLower and NoErrPeriodUpper are in minutes. These named values are described below.

If two consecutive errors occur in a period less than NoErrPeriodLower, the application manager will move up the recovery policy immediately. If the no-error period is longer than NoErrPeriodLower but shorter than NoErrPeriodUpper, the application manager will increment a counter and stay on the base policy as long as the counter is not larger than NumTriesOnBasePolicy. If the counter exceeds NumTriesOnBasePolicy, the application manager will move up the policy. If the no-error period is longer than NoErrorPeriodUpper, the application manager will stay on the base policy and reset the counter to zero. For instance, NoErrPeriodLower=one hour, NoErrPeriodUpper=10 hour and NumTriesOnBasePolicy=3 will give the application manager some intelligence to deal with most likely error situations.

The last named value under a sub key is SkipLevel [DWORD]. If SkipLevel has a non-zero value, the application manager will skip Logoff User and move up to Reboot NT directly from Restart Process whenever necessary.

In order to log messages properly in NT Event Logger, AmEventLogMsg.dll will be invoked when a WD timer fires. It contains all of the application manager-related messages. The following registry is an example of a setup to use the message DLL file:

HKEY_LOCAL_MACHINE\System\CurrentControlSet\Ser vices\EventLog\Application

The key is called AppMgr, which has two named values. The first is EventMessageFile, which gives the full path for the message DLL file. The second is TypesSupported, which is a bit mask to specify which message types are supported. A value of 7 indicates that AppMgr supports all error, warning and informational messages.

An embodiment of the invention utilizes a COM server called IMessageRegistrar in the application manager to facilitate IPCs in the system. This provides a convenient and consistent IPC architecture.

To post a thread message across process boundaries, the thread ID for the receiving threads is all that must be known, which will be valid across the system. ImessageRegistrar provides a service to determine the thread ID for the receiver.

The Application Manager (AM) MessageRegistrar is designed with the following assumptions. Determining which messages an application will receive is a design time or compile-time decision. The thread RegisterMessages is only called once during the initialization of a message-receiving thread. Because of different runtime activities, a message-receiving thread may come and go and the thread Ids may change. An application only has one thread to receive messages from outside of the process.

MessageRegistrar does not necessarily have to keep track of the lifetime of each message-receiving thread. Each monitored application will check the return value from PostThreadMessage while using a thread ID from either GetTIDsForMsg or GetAIDsAndTIDsForMsg. If the thread ID is invalid, it is because that thread has died. The functions GetTIDsForMsg or GetAIDsAndTIDsForMsg can be called again to see whether there is a new thread ID in the MessageRegistrar, because the thread has recovered due to either the application manager or the application itself.

Each custom message returns two parameters, wParam and IParam. How the meaning of wParam and IParam is interpreted is up to the agreement between sender and receiver, and has little or nothing to do with MessageRegistrar.

The Application Manager Message Registrar supports a simple COM interface derived from IUnknown with the following three methods.

1. RegisterMessages

AppId is provided as an integer. If an integer identification does not exist for an application, one must be added to the file. The threadld is the ID for the message-receiving thread. The numMsgs is the number of the message in msgList. The msgList is the actual list of messages to be placed in a register.

An exemplary syntax is:

RegisterMessages([in] long appId, [in] DWORD threaded, [in] long numMsgs, [in] long msgList[ ]);

2. GetIDsForMsg

This method returns the thread Ids for a given message. The msg is the message. The pSize is a pointer to the number of the thread Ids in threadIds. The threadIds is the actual list for the thread Ids.

The example syntax is:

GetTIDsForMsg([in] long msg, [out] long *pSize, [out] DWORD **threadIds);

3. GetAIDsAndTIDsForMsg

This process returns application Ids and Thread Ids for a given message. The notation “msg” refers to the message. The pSize is a pointer to the number of the thread Ids in threadIds. The appIds is the integer defined for the application. The threadIds is the actual list for the thread Ids.

An example syntax is:

GetAIDsAndTIDsForMSG([in] long msg, [out] long *pSize, [out] long **appIds, [out] DWORD **threadIds);

There are multiple levels of recovery. The higher the level, the longer the time is needed to perform the recovery, and the more interruption a user may experience. Therefore, it is contemplated that a lower level recovery will be executed first if possible. For example, the Level One Recovery 410 is implemented inside a process, insulated from all other processes.

From the application manager's perspective, the Level Two Recovery 420 is the least severe action to take if a dead process is detected. There are two major reasons that might prevent a Level Two Recovery from being executed. First, if a process has some direct access to kernel components, NT drivers or even some hardware, trying to start a new instance of the dead process without going through a normal startup process may cause some unexpected results. Second, if a process serves as a COM server and some other client process are holding COM interface pointers to the server, trying to start a new instance of the dead server process will cause runtime problems. If a client process is stalled for some reason, and it is still holding some COM interface pointers to some other server processes, the stalled client process can be eliminated, and a new instance of it started. For each application process, the recovery policy should be specified delivered to the application manager through either Windows NT registry or a system configuration file.

The following is an exemplary tree structure for the registry keys and values required by the Application Manager:

HKEY_LOCAL_MACHINE\SOFTWARE\Manager\

[DWORD] ConnectionEnabled: 0/1

[DWORD] RecoveryEnabled: 0/1

[STRING] LogoffProcess

[STRING] ManagedList: “Name1; Name2; . . . ”

[SUBKEY] Name1\

[DWORD] RecoveryLevel: 2 (or 3, 4)

[STRING] Group: UserApp (or NTService)

[DWORD] NoErrPeriodLower

[DWORD] NoErrPeriodUpper

[DWORD] NumTriesOnBasePolicy

[DWORD] SkipLevel

In one embodiment, both ConnectionEnabled and RecoveryEnabled can be set to 1. For a debug build, they can be either 0 (disabled) or 1 (enabled). If ConnectionEnabled is set to 0, the Application Manager Connector sitting in a managed application will not try to connect to the Application Manager. If RecoveryEnabled is set to 0, the Application Manager will not try to recover a hung system. These features can be added for debugging purpose. The names in the ManagedList and corresponding sub keys must be the executable name without the extension, for examples, TVGateway and ComPlayer.

Each application is configured to periodically connect to the application manager and report, “I am still alive.” A COM object called AmConnector facilitates the connection. The connector can be used just like any other COM object, to talk to the application manager directly. For example, AmConnContainer is a template class. The template parameters dictate the types of connectors and their interfaces. The default types for the parameters are provided from AmConnector. One solution is to let the AmConnector sit in the main thread of an application and communicate with the application manager on behalf of the application.

The AmConnContainer can be used as one of the base classes of the main class: using the default behavior from the connector is probably the easiest way to use the connector and its container. An example of the basic code for TVGateway is:

// TVGatewayDlg.h

#include “..\..\Application Manager\Src\AmConnContainer\AmConnContainer.h”

class TVGatewayDlg: public CDialog, public CAmConnContainer< >

These two lines of code define a template for instantiating the AmConnector in the main thread, and the connector will initialize the connection to the application manager and update the application manager timer periodically using the default timeout interval. On top of these, a public data member, called m_pConnector, is provided in the main class. Because m_pConnector is a smart pointer to the COM interface in AmConnector, it can be used to access any methods and properties in the interface.

The AmConnContainer creates a data member in the main class. If the default timeout interval is not used, this data member approach can be used instead of the inheritance approach. The constructor for the container class has a single Boolean parameter, bStart, with the default value set to true. In this embodiment, the timer should not be started right away. To start the timer, the container instance should be created with bStart set to false. Then after the construction, m_pConnector can be used to set the property, 1Timeout, to whatever value desired. Then, StartTheTimer( ) can be called to start feeding the Application Manager timer periodically using the desired timeout interval. The m_pConnector can be used to access all of the methods and properties from the connector.

The AmConnector is a regular ATL INPROC COM object, having many different uses. The two methodologies described above are merely demonstrative, and should not be read as limiting the scope of this invention in any way.

Using AM MessageRegistrar

The following example shows how to call the methods in the interface. Exactly how the methods are used depends on the application or applications being monitored. This example is for example only, and not to be taken as limiting the invention.

### CODING EXAMPLE

CcomPtr<ImessageRegistrar> ptrMsgReg;
hr = ::CoCreateInstance(CLSID_MessageRegistrar, NULL,

CLSCTX_LOCAL_SERVER,

IID_IMessageRegistrar,

(void**) &ptrMsgReg) ;

if(SUCCEEDED(hr))

// the list of messages Application Manager would

like to receive

long msgList[2] = {WM_CTV_AM_REBOOT,
WM_CTV_TEST} ;
DWORD dwThreadId = ::GetCurrentThreadId() ;
hr = ptrMsgReg->RegisterMessages(APPID_AM,

dwThreadid, 2, msgList) ;

if (SUCCEEDED(hr)) {

DWORD *pThreadIds;
long numTIDs;
hr = ptrMsgReg->GetTIDsForMsg(WM_CTV_TEST,

&numTIDs, &pThreadIds) ;

// If you don't need pThreadIds any more
::CoTaskMemFree(pThreadList) ;

}
if(SUCCEEDED(hr)) {

long *pAppList, numApps = 0;
DWORD *pThreadList;
hr = m ptrMsgReg-

>GetAIDsAndTIDsForMsg(WM_CTV_GW_TEST, &numApps,
&pAppList, &pThreadList) ;

if(SUCCEEDED(hr) && numApps > 0) {

BOOL bRet;
for(int i = 0; i < numApps; i++) {

bRet =

::PostThreadMessage((DWORD)pThreadList[i] ,

WM_CTV_GW_TEST, 0,

NULL);_ASSERTE(bRet) ;

}

}
::CoTaskMemFree(pAppList) ;
::CoTaskMemFree(pThreadList) ;

}

}

User Mode Functions

The User Mode can be set by the Configurator. To set the system to User Mode, from the Configurator application, the Autologon Option is set to User Autologon. The application manager is only functional if the system is logged on as AutoLogon.

At system start-up, the application manager checks the status of the keyboard and mouse drivers. If the client is configured for User Autologon mode (i.e. the client configuration in the end-user environment) when either driver fails, the application manager restarts (i.e. a warm boot) the client.

If the application manager detects that TVGateway is not responding, it takes the following actions in the order listed to initiate an orderly recovery: The application manager waits for one minute to give TVGateway time to recover on its own. If there is no response after one minute, the application manager closes and then restarts TVGateway. If TVGateway still does not respond, the application manager informs NT to log off the current user and then logs on again. This stops and then restarts all the ConnectTV application programs. If TVGateway still does not respond, the application manager forces a hardware reset through the PIC board.

If SOCPlayer or PIC_Service “hang” or stop for any reason, the application manager will reboot NT by forcing a hardware reset through the PIC board.

An Administrator Mode is set by the Configurator. To set the system to Administrator Mode, from the Configurator application, the Autologon Option is set to Administrator Autologon. The application manager is only functional if the system is logged on as AutoLogon.

In this mode, The application manager checks the status of the keyboard and mouse drivers at system start-up. If the client is in Administrator Mode, then a message window is displayed to indicate that the failure has been detected but no further action is taken.

When the client is in Administrator mode, pressing ESC (when the Debug option in the Configurator is set to “1”) will close TVGateway.exe and display the Windows NT desktop. This does not trigger the application manager's failure recovery protocol because TVGateway would be closed in an orderly way that does not flag it as a failure.

Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. A method for managing application resources in a streaming media retrieval system, comprising:
monitoring a set of application processes for a state message periodically transmitted by each application process; and
if an expected state message is not received from one of the application processes within the period, initiating one of a plurality of recovery processes.

2. A method of monitoring one or more applications running in an application environment, wherein each application executes at least one process, comprising:
monitoring one or more applications for periodic state messages generated by each application process that is running;
when no state message is received, recording an error for the associated application process; and
based on the recorded error, automatically executing one of a plurality of recovery processes.

3. The method of claim 2, wherein monitoring one or more applications for periodic state messages includes implementing a monitor process for each application process thread generated by the application.

4. The method of claim 3, wherein automatically executing one of a plurality of recovery processes includes eliminating the application process thread that has failed, and starting a new application process thread.

5. The method of claim 2, wherein monitoring one or more applications for periodic state messages includes implementing a monitor process for each application process of the application.

6. The method of claim 5, wherein automatically executing one of a plurality of recovery processes includes eliminating the application process that has failed, and starting a new application process.

7. The method of claim 6, further comprising storing a history of the recovery procedure in a memory.

8. The method of claim 6, wherein automatically executing one of a plurality of recovery processes further includes, initiating a logoff from and subsequent logon to the application environment.

9. The method of claim 8, wherein automatically executing one of a plurality of recovery processes further includes rebooting the operating system software that hosts the application environment.

10. The method of claim 5, wherein monitoring one or more applications for periodic state messages further includes implementing a monitor process for all other monitor processes.

11. The method of claim 10, wherein automatically executing one of a plurality of recovery processes further includes initiating a hardware reset via the operating system software.

12. The method of claim 11, wherein automatically executing one of a plurality of recovery processes further includes initiating a switch to a backup operating system partition.

13. A system for monitoring one or more applications running in an application environment, wherein each application executes at least one process, comprising:
a monitor program having a kernel timer configured to monitor for periodic state messages generated by an application process that is running;
a plurality of recovery procedures, stored as instructions in one or more files associated with the monitor program; and
logic, linked with the monitor program and responsive to the kernel timer when no state message is received, configured to register an error for the associated application process and to automatically execute one of the plurality of recovery procedures based on the error.

14. The system of claim 13, further comprising a memory, in which a history of recovery procedures are stored upon being executed by the logic.

15. The system of claim 13, wherein the plurality of recovery procedures includes instructions to eliminate an application process that has failed.

16. The system of claim 15, wherein the plurality of recovery procedures further includes starting a new application process in place of the eliminated application process.

17. The system of claim 13, wherein the plurality of recovery procedures includes instructions to reboot the operating system that hosts the application environment.

18. The system of claim 17, wherein the plurality of recovery procedures further includes instructions to initiate a hardware reset via the operating system software.

19. The system of claim 13, wherein the monitor program further includes a self-monitoring process.

20. The system of claim 13, wherein the plurality of recovery procedures includes instructions to switch to a backup operating system partition.
